(19) United States
(12) Patent Application Publication
(10) Pub. No.: US 2006/0224715 A1
(43) Pub. Date: Oct. 5, 2006

(54) Computer management program, managed computer control program, computer management apparatus, managed computer, computer management system, computer management method, and managed computer control method

(75) Inventors: Yuichiro Ajima, Kawasaki (JP); Akihiro Yasuo, Kawasaki (JP); Yoshiro Ikeda, Kawasaki (JP); Atsushi Mori, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 11/336,935

(22) Filed: Jan. 23, 2006

(30) Foreign Application Priority Data
Apr. 3, 2005 (JP) 2005-059872

(51) Int. Cl. G06F 15/173

(52) U.S. Cl. 709/223

(57) ABSTRACT

The present invention has been made to provide a computer management program, a managed computer control program, a computer management apparatus, a managed computer, a computer management system, a computer management method, and a managed computer control method allowing the management agent to easily perform autonomous communication frequency control. A computer management program allowing a computer to execute: a communication processing step that receives a request message from the managed computer, writes information from the managed computer in a management registry, and reads out information for the managed computer from the management registry so as to transmit a result of the readout operation to the managed computer as a reply message; and a management processing step that reads out information from the managed computer in the management registry, performs management processing for the managed computer according to a result of the readout operation, and writes information for the managed computer, which is to be obtained by a result of the management processing, in the management registry.

### BACKGROUND OF THE INVENTION

1. Field of the Invention

The present invention relates to a computer management program, a managed computer control program, a computer management apparatus, a managed computer, a computer management system, a computer management method, and a managed computer control method for managing a computer on a network.

2. Description of the Related Art

The computer management system is a system for managing a plurality of computers. FIG. 9 is a block diagram showing a configuration example of a conventional first computer management system. The computer management system of FIG. 9 includes a computer management apparatus 101 and a plurality of managed computers 102. The computer management apparatus 101 and plurality of managed computers 102 are connected to each other through a network 3 and perform communication with each other by a management protocol constructed on the basis of a network protocol such as TCP/IP (Transmission Control Protocol/Internet Protocol). The computer management apparatus 101 includes a management communication processing section 112 and a management inventory 111 and manages the plural managed computers 102. Each of the managed computers 102 includes a management agent 121.

The management agent 121 periodically acquires the state information of the managed computer 102 and transmits the state information to the computer management apparatus 101 as a state information message. The state information is a result measured by the managed computer 102 and includes CPU (Central Processing Unit) load, CPU temperature, memory usage, and the like. The management communication processing section 112 collects the state information transmitted from the plural management agents 121 and stores them in the management inventory 111. The management communication processing section 112 then determines whether it is necessary to perform control for the managed computers 102 based on the state information stored in the management inventory 111. When determining that control for a given managed computer 102 is necessary, the management communication processing section 112 transmits an instruction message to the corresponding management agent 121. The management agent 121 that has received the instruction message performs operation according to the instruction message.

FIG. 10 is a sequence diagram showing an example of operation of the conventional first computer management system. Information A in the example of FIG. 10 is the state information to be transmitted from the management agent 121 to the management communication processing section 112 and is, for example, the state information measured in the managed computer 102. Information B in the example is the instruction information transmitted from the management communication processing section 112 and is, for example, an instruction to stop a service in operation, instruction to transfer the control of a service in operation from one node to another, or the like. Information B′ is a reply to the information B and indicates, for example, completion of the instruction of the information B. Information C is a request issued from the management agent 121 to the management communication processing section 112 and is, for example, a request to transfer the control of a service in operation from one node to another. Information C′ is a reply to the information C and is, for example, an IP address of a node to which the control of a service in operation is transferred.

The management agent 121 transmits the information A to the management communication processing section 112 (T111). Upon receiving the information A, the management communication processing section 112 stores the information A in the management inventory 111 (T113). The management agent 121 transmits the information C to the management communication processing section 112 (T121). The management communication processing section 112 transmits information B to the management agent 121 (T132). After a predetermined time has elapsed since the transmission of the information A, the management agent 121 transmits the information A once again to the management communication processing section 112 (T141). Upon receiving the information A, the management communication processing section 112 stores the information A in the management inventory 111 (T142). When completing the processing corresponding to the received information C, the management communication processing section 112 transmits the information C′, which is a reply to the information C, to the management agent 121 (T127) and stores the information C′ in the management inventory 111 (T128). When completing the processing corresponding to the received information B, the management agent 121 transmits the information B′, which is a reply to the information B, to the management communication processing section 112 (T146). Upon receiving the information B′, the management communication processing section 112 stores the information B′ in the management inventory 111 (T148). After a predetermined time has elapsed since the transmission of the information A, the management agent 121 transmits the information A once again to the management communication processing section 112 (T151). Upon receiving the information A, the management communication processing section 112 stores the information A in the management inventory 111 (T153).

In the above first computer management system, respective information are transmitted as soon as they are requested, so that communication frequency increases with an increase in the number of state information or instructions. As communication frequency increases, CPU time to be used in management protocol processing increases. Therefore, processing to be performed by the management agent 121 needs to be processing that puts less of a load on the CPU. Further, in the case where the CPU load of the managed computer 102 is high, control that reduces the CPU load of the management agent 121 is required.

In order to cope with the above problem, the first computer management system is modified to obtain a second computer management system. Although the second computer management system has the same configuration as that of the first computer management system, it is configured to delay a message transmission in order to control the communication frequency to thereby transmit different types of messages in bulk. FIG. 11 is a sequence diagram showing an example of operation of the conventional second computer management system. In FIG. 11, the same reference numerals denote the same or corresponding processing as in FIG. 10, and the descriptions thereof will be omitted. The contents of information A, information B, information B′, information C, and information C′ are the same as those in FIG. 10.

The operation of FIG. 11 will be described with comparison to that of FIG. 10. In the second computer management system, the management agent 121 delays transmission (T121) of the information C until the start of subsequent transmission (T141) of the information A to thereby transmit information AC obtained by combining the two information (T241). Upon receiving the information AC, the management communication processing section 112 stores the information A in the management inventory 111 (T243) and performs processing corresponding to the received information C. After completing the above processing, the management communication processing section 112 transmits the information C′, which is a reply to the information C, to the management agent 121 (T247) and stores the information C′ in the management inventory 111 (T248). The management agent 121 delays transmission (T146) of the information B′, which is a reply to the information B (T132), until the start of subsequent transmission (T151) of the information A and transmits information AB′ obtained by combining the two information (T251). Upon receiving the information AB′, the management communication processing section 112 stores the information AB′ in the management inventory 111 (T253).

With the above operation, it is possible to reduce the communication frequency from the management agent 121 to the management communication processing section 112.

As a prior art related to the present invention, Jpn. Pat. Appln. Laid-Open Publication No. 2004-110791 is known. The dynamic adaptive server provisioning for blade architectures in this publication receives server performance information from an application server pool provided in the rack of a rackmount blade computer assembly and assigns a blade server to be used by the application server pool from a free server pool.

### SUMMARY OF THE INVENTION

However, in order to control the frequency of data transmission from the management communication processing section 112 to the management agent 121, the management communication processing section 112 needs to perform the delay/aggregation control of messages. Further, in order for the management agent 121 to control the frequency of the message transmitted by the management communication processing section 112 in accordance with the operation state of the managed computer 102, the management agent 121 needs to transmit information such as a permissible delay time or a communication frequency expectation value to the management communication processing section 112 to thereby request it to control the communication frequency. As described above, in the conventional computer management system, additional communication for the control of the communication frequency is indispensable, making the configuration thereof complicated and unpractical.

The present invention has been made to solve the above problem and an object thereof is to provide a computer management program, a managed computer control program, a computer management apparatus, a managed computer, a computer management system, a computer management method, and a managed computer control method allowing the management agent to easily perform autonomous communication frequency control.

To solve the above problem, according to a first aspect of the present invention, there is provided a computer management program allowing a computer to execute a computer management method for managing one or more managed computers, the program allowing the computer to execute: a communication processing step that receives a request message from the managed computer, writes information from the managed computer in a management registry that stores information for managing the managed computer in the case where the request message includes a write request, and reads out information for the managed computer from the management registry so as to transmit a result of the readout operation to the managed computer as a reply message in the case where the request message includes a readout request; and a management processing step that reads out information of the managed computer from the management registry, performs management processing for the managed computer according to a result of the readout operation, and writes information for the managed computer, which is to be obtained by a result of the management processing, in the management registry.

In the computer management program according to the present invention, the communication processing step inhibits another access to the management registry while the communication processing step accesses the management registry.

In the computer management program according to the present invention, the communication processing step or management processing step sets a survival time for each entry in the management registry and initializes the entry when a time has elapsed exceeding the survival time for the entry since the last update time thereof.

According to a second aspect of the present invention, there is provided a managed computer control program communicating with a computer management apparatus and allowing a computer to execute a managed computer control method that controls the managed computer, the program allowing the computer to execute: a state monitor step that monitors the state of the managed computer and acquires the state of the managed computer as state information; a request message transmission step that transmits a request message to the computer management apparatus according to the state information; a reply message reception step that receives a reply message corresponding to the request message from the computer management apparatus; a management control step that controls the managed computer according to the reply message; and a frequency control step that controls, according to the state information, the frequency of transmission performed by the request message transmission step.

In the managed computer control program according to the present invention, the state information includes a CPU load of the managed computer.

In the managed computer control program according to the present invention, the request message transmission step previously stores, as a request message template, a request message to be repeatedly used and, when there is a request to transmit the request message to be repeatedly used, transmits the corresponding stored request message template.

According to a third aspect of the present invention, there is provided a computer management apparatus that manages one or more managed computers, comprising: a management registry that stores information for managing the managed computer; a communication processing section that receives a request message from the managed computer, writes information from the managed computer in a management registry in the case where the request message includes a write request, and reads out information for the managed computer from the management registry so as to transmit a result of the readout operation to the managed computer as a reply message in the case where the request message includes a readout request; and a management processing section that reads out information from the managed computer in the management registry, performs management processing for the managed computer according to a result of the readout operation, and writes information for the managed computer, which is to be obtained by a result of the management processing, in the management registry.

In the computer management apparatus according to the present invention, the communication processing section inhibits another access to the management registry while the communication processing section accesses the management registry.

In the computer management apparatus according to the present invention, the communication processing section or management processing section sets the survival time for each entry in the management registry and initializes the entry when a time has elapsed exceeding the survival time for the entry since the last update time thereof.

According to a fourth aspect of the present invention, there is provided a managed computer that communicates with a computer management apparatus and is managed by the same, comprising: a state monitor section that monitors the state of the managed computer and acquires the state of the managed computer as state information; a request message transmission section that transmits a request message to the computer management apparatus according to the state information; a reply message reception section that receives a reply message corresponding to the request message from the computer management apparatus; a management control section that controls the managed computer according to the reply message; and a frequency control section that controls, according to the state information, the frequency of transmission performed by the request message transmission section.

In the managed computer according to the present invention, the state information includes the CPU load of the managed computer.

In the managed computer according to the present invention, the request message transmission section previously stores, as a request message template, a request message to be repeatedly used and, when there is a request to transmit the request message to be repeatedly used, transmits the corresponding stored request message template.

According to a fifth aspect of the present invention, there is provided a computer management system that manages computers on a network, comprising: one or more managed computers to be managed; and a computer management apparatus that communicates with the managed computer to thereby manage the same. The managed computer comprises: a state information acquisition section that acquires the state information of the managed computer; a request message transmission section that transmits a request message to the computer management apparatus according to the state information; a reply message reception section that receives a reply message corresponding to the request message from the computer management apparatus; a management control section that controls the managed computer according to the reply message; and a frequency control section that controls, according to the state information, the frequency of transmission performed by the request message transmission section. The computer management apparatus comprises: a management registry that stores information for managing the managed computer; a communication processing section that receives a request message from the managed computer, writes information from the managed computer in a management registry in the case where the request message includes a write request, and reads out information for the managed computer from the management registry so as to transmit a result of the readout operation to the managed computer as a reply message in the case where the request message includes a readout request; and a management processing section that reads out information of the managed computer from the management registry, performs management processing for the managed computer according to a result of the readout operation, and writes information for the managed computer, which is to be obtained by a result of the management processing, in the management registry.

According to a sixth aspect of the present invention, there is provided a computer management method that manages one or more managed computers, comprising: a communication processing step that receives a request message from the managed computer, writes information from the managed computer in a management registry that stores information for managing the managed computer in the case where the request message includes a write request, and reads out information for the managed computer from the management registry so as to transmit a result of the readout operation to the managed computer as a reply message in the case where the request message includes a readout request; and a management processing step that reads out information of the managed computer from the management registry, performs management processing for the managed computer according to a result of the readout operation, and writes information for the managed computer, which is to be obtained by a result of the management processing, in the management registry.

According to a seventh aspect of the present invention, there is provided a managed computer control method that communicates with a computer management apparatus and controls a managed computer, comprising: a state monitor step that monitors the state of the managed computer and acquires the state of the managed computer as state information; a request message transmission step that transmits a request message to the computer management apparatus according to the state information; a reply message reception step that receives a reply message corresponding to the request message from the computer management apparatus; a management control step that controls the managed computer according to the reply message; and a frequency control step that controls, according to the state information, the frequency of transmission performed by the request message transmission step.

According to the present invention, the access of the management processing section and communication processing section to the management registry allows the computer management apparatus and managed computer to autonomously process information. Further, in the computer management apparatus, the lock of the management registry during the processing of the communication processing section allows the communication processing section to perform processing without influence of an access made by another processing. Further, by setting survival time in an entry in the management registry and by initializing the entry when a time has elapsed exceeding the survival time for the entry since the last update time thereof, it is possible to prevent a given entry from being occupied even if a managed computer fails and a reply from it cannot be transmitted.

Further, the management agent can autonomously control the type of an instruction and communication frequency by referring to the management registry, thereby controlling the CPU load of the management agent. Further, by previously storing a request message to be repeatedly used in the request template buffer for repetitive use of the message, it is possible to reduce the number of times of processing that creates a request message, thereby reducing the CPU load of the management agent.

### BRIEF DESCRIPTION OF THE DRAWINGS

FIG. 1 is a block diagram showing an example of a configuration of a computer management system according to the present invention;

FIG. 2 is a view showing an example of a format of a management registry according to the present invention;

FIG. 3 is a flowchart showing an example of operation of a communication processing section in the computer management apparatus according to the present invention;

FIG. 4 is a flowchart showing an example of operation of the communication processing section in the computer management apparatus according to the present invention at the time when performing management registry processing;

FIG. 5 is a flowchart showing an example of the initial operation of a management agent according to the present invention;

FIG. 6 is a flowchart showing an example of the normal operation of the management agent according to the present invention;

FIG. 7 is a view showing an example of a format of a request message according to the present invention;

FIG. 8 is a sequence diagram showing an example of operation of the computer management system according to the present invention;

FIG. 9 is a block diagram showing a configuration example of a conventional first computer management system;

FIG. 10 is a sequence diagram showing an example of operation of the conventional first computer management system; and

FIG. 11 is a sequence diagram showing an example of operation of the conventional second computer management system.

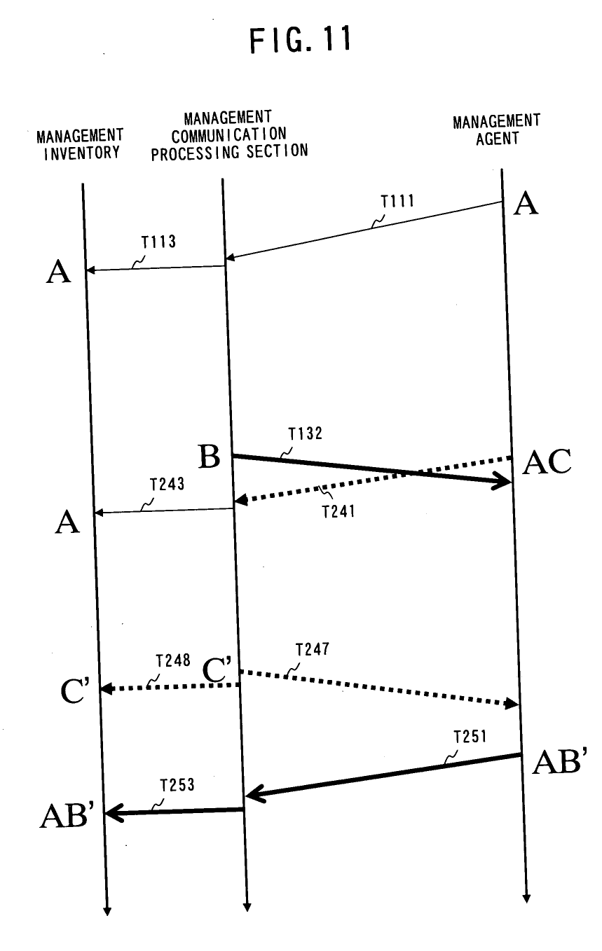

### DETAILED DESCRIPTION OF THE PREFERRED EMBODIMENTS

An embodiment of the present invention will be described below with reference to the accompanying drawings.

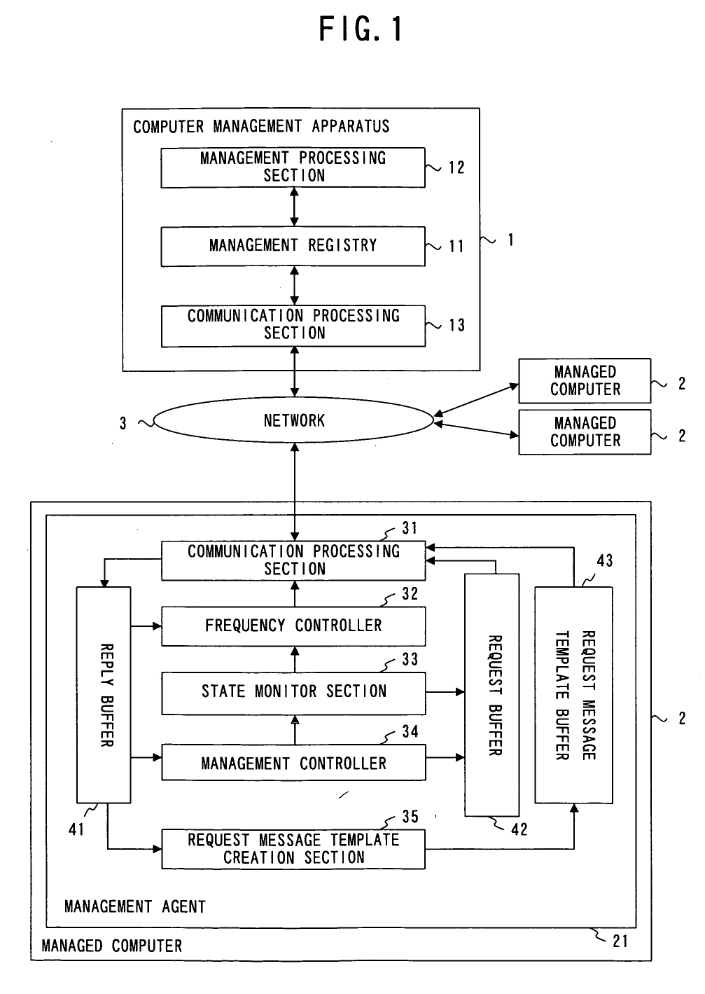

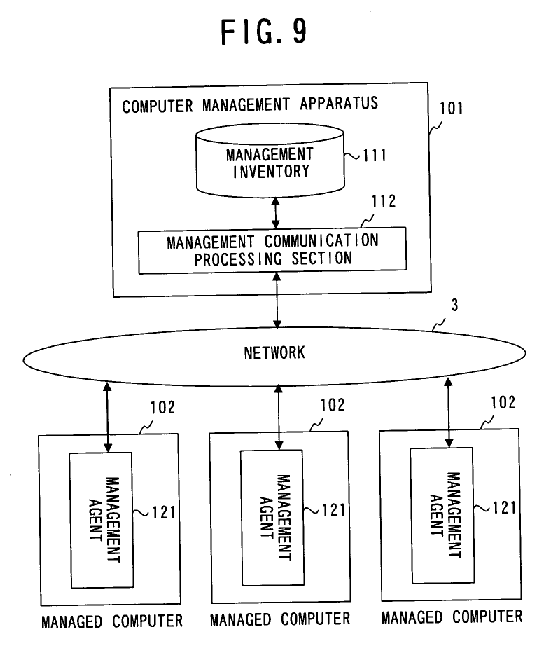

A configuration of a computer management system according to the present invention will firstly be described. FIG. 1 is a block diagram showing an example of a configuration of the computer management system according to the present invention. In FIG. 1, the same reference numerals denote the same or corresponding components as in FIG. 9, and the descriptions thereof will be omitted. As compared to FIG. 9, it can be seen that the computer management system of FIG. 1 includes a computer management apparatus 1 and managed computers 2 in place of the computer management apparatus 101 and managed computers 102.

The computer management apparatus 1 includes a management registry 11, a management processing section 12, a communication processing section 13, and a survival time file 14. Each of the managed computers 2 has a management agent 21. The management agent 21 includes a communication processing section 31, a frequency controller 32, a state monitor section 33, a management controller 34, a request message template creation section 35, a reply buffer 41, a request buffer 42, and a request message template buffer 43. The request message template buffer 43 is a buffer for storing request messages to be repeatedly used as templates. The request buffer 42 is a buffer for temporarily storing a request for the computer management apparatus 1. The reply buffer 41 is a buffer for temporarily storing a reply from the computer management apparatus 1.

The components constituting the computer management apparatus 1 will next be described.

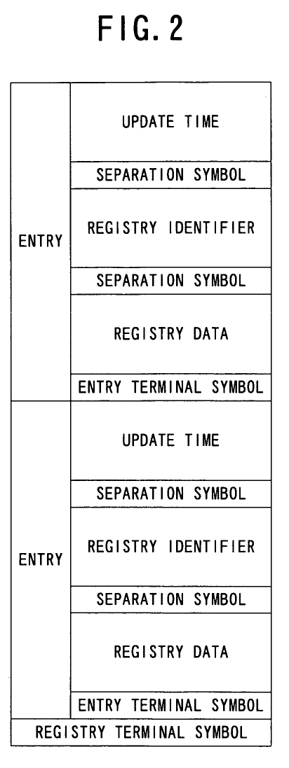

The management registry 11 is a file that records the state information of the managed computer 2 and progress of various controls. FIG. 2 is a view showing an example of a format of the management registry according to the present invention. The management registry is recorded in units of an entry and ends with a registry terminal symbol. One entry includes items of update time, registry identifier, and registry data. Each item is separated with a separation symbol and each entry ends with an entry terminal symbol. When information of a new type is to be recorded, a new entry is created for recording thereof. Information of the type that has already existed in the management registry is recorded in the same existing entry.

The survival time file 14 is a file that records the survival time of each entry in the management registry. Accordingly, the survival time is recorded in units of an entry. One entry includes items of the same registry identifier as that of the corresponding entry in the management registry 11 and survival time thereof.

The management processing section 12 reads out the state information of the managed computer 2 and progress of control operations from the management registry 11. If any control is necessary, the management processing section 12 writes an instruction of control operation in the corresponding entry in the management registry 11.

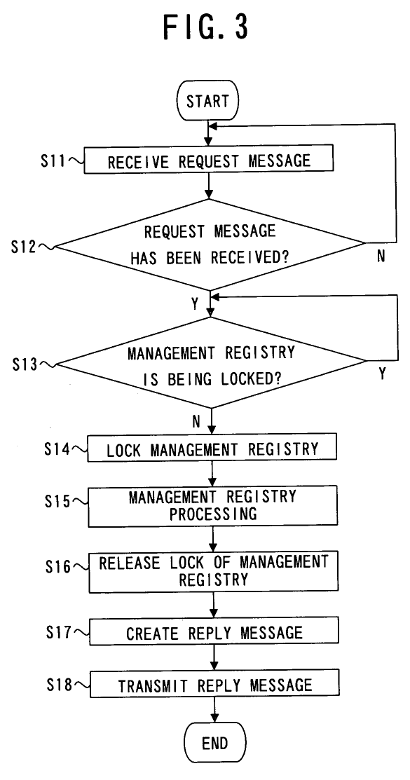

Next, operation of the communication processing section 13 will be described. FIG. 3 is a flowchart showing an example of operation of the communication processing section in the computer management apparatus according to the present invention. The communication processing section 13 receives a request message from the management agent 21 (S11). The communication processing section 13 then determines whether the request message has been received (S12). When determining that the request message has not been received (N in S12), the communication processing section 13 returns to step S11. On the other hand, when determining that the request message has been received (Y in S12), the communication processing section 13 determines whether the file of the management registry 11 is being locked (S13). When determining that the management registry 11 is being locked (Y in S13), the communication processing section 13 returns to step S13. On the other hand, when determining that the management registry 11 is not being locked (N in S13), the communication processing section 13 locks the file of the management registry 11 (S14).

The communication processing section 13 then performs management registry processing to be described later (S15) and, after the completion of the management registry processing, releases the lock of the management registry 11 (S16). The communication processing section 13 then creates a reply message based on a readout result from the management registry 11 (S17), transmits the reply message to the management agent 21 (S18), and ends this flow. Thereafter, this flow is repeatedly carried out.

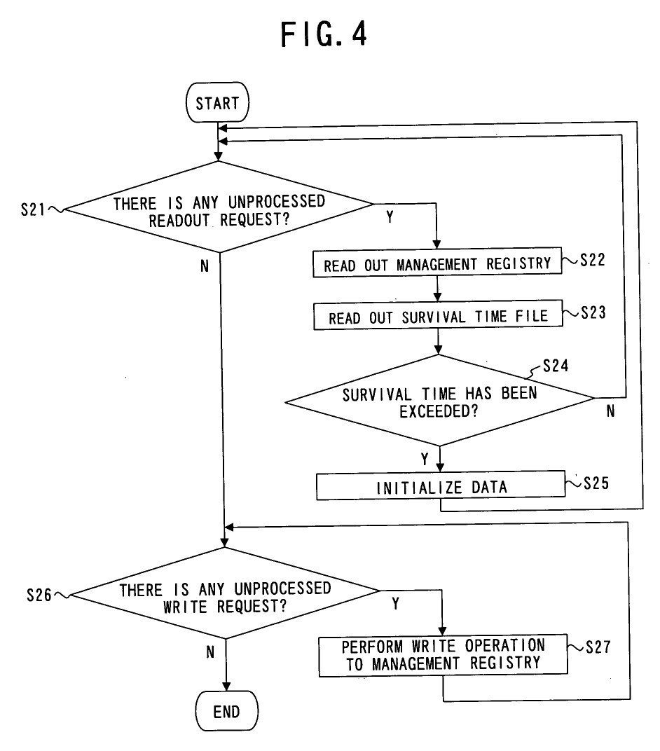

Next, details of the management registry processing performed by the communication processing section 13 will be described. FIG. 4 is a flowchart showing an example of operation of the communication processing section in the computer management apparatus according to the present invention at the time when performing management registry processing.

The communication processing section 13 determines whether there is any unprocessed readout request in the management registry 11 (S21). When determining that there is any unprocessed readout request (Y in S21), the communication processing section 13 reads out an entry corresponding to the unprocessed request from the management registry 11 (S22). The communication processing section 13 then reads out an entry corresponding to the request from the survival time file 14 (S23) and uses update time read out from the management registry 11, survival time read out from the survival time file 14, and current time to determine whether (current time-update time) exceeds the survival time (S24). When determining that (current time-update time) does not exceed the survival time (N in S24), the communication processing section 21 returns to step S21. On the other hand, when determining that (current time-update time) has exceeded the survival time (Y in S24), the communication processing section 21 initializes the data of the entry that has been read out from the management registry 11 (S25) and returns to step S21.

When determining, in step S21, that there is no unprocessed readout request (N in S21), the communication processing section 13 determines whether there is any unprocessed write request in the management registry 11 (S26). When determining that there is any unprocessed write request (Y in S26), the communication processing section 13 writes data in an entry corresponding to the unprocessed request in the management registry 11 (S27) and returns to step S26. On the other hand, when determining that there is no unprocessed write request (N in S26), the communication processing section 13 ends this flow.

As described above, the access of the management processing section 12 and communication processing section 13 to the management registry 11 allows the computer management apparatus 1 and managed computer 2 to autonomously process information. Further, the lock of the management registry 11 during the processing of the communication processing section 13 allows the communication processing section 13 to perform processing without influence of an access made by another processing. Further, by setting survival time in an entry in the management registry 11 and by initializing the entry when a time has elapsed exceeding the survival time for the entry since the last update time thereof, it is possible to prevent a given entry from being occupied even if a managed computer fails and a reply from it cannot be transmitted.

Next, operation of the management agent 21 in the managed computer 2 will be described.

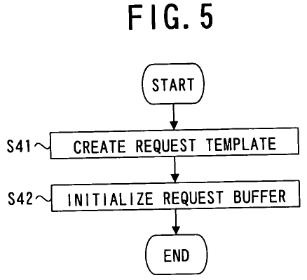

FIG. 5 is a flowchart showing an example of the initial operation of the management agent according to the present invention. The request message template creation section 35 creates a request message to be repeatedly used according to the state of the managed computer 2 and stores it in the request message template buffer 43 as a request message template (S41). The state monitor section 33 initializes the request buffer 42 (S42) and this flow is ended. Subsequently, the management agent 21 executes normal operation flow.

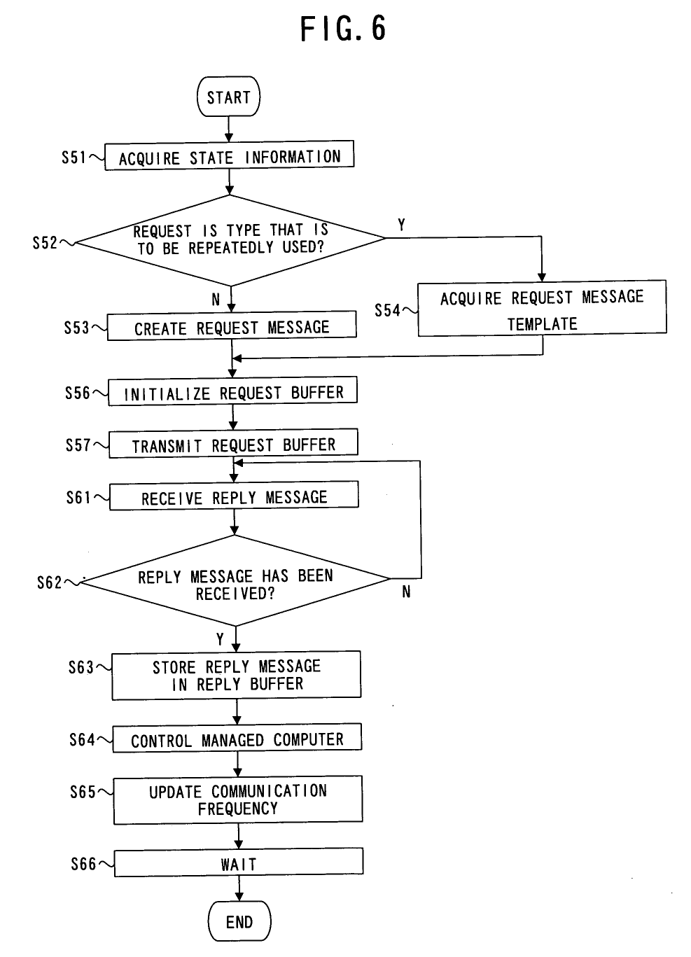

FIG. 6 is a flowchart showing an example of the normal operation of the management agent according to the present invention. The state monitor section 33 acquires the state information of the managed computer 2 (S51) and writes it in the request buffer 42. Then the communication processing section 31 determines whether the request is a type that is to be repeatedly used (S52). When determining that the request is not a type that is to be repeatedly used (N in S52), the communication processing section creates the content written in the request buffer 42 as a request message (S53) and shifts to step S56. On the other hand, when determining that the request is a type that is to be repeatedly used (Y in S52), the communication processing section 31 acquires the corresponding request message plate stored in the request message template buffer 43 as a request message (S54). The communication processing section 31 then initializes the request buffer 42 (556) and transmits the request message to the communication processing section 13 (S57).

The communication processing section 31 then receives a reply message from the communication processing section 13 (S61). Subsequently, the communication processing section 31 determines whether the reply message has been received (S62). When determining that the reply message has not been received (N in S62), the communication processing section 31 returns to step S61. On the other hand, when determining that the reply message has been received (Y in S62), the communication processing section 31 stores the content of the reply message in the reply buffer 41 (S63). Then the management controller 34 performs control for the managed computer 2 according to the content stored in the reply buffer 41 (S64). Next, the frequency controller 32 updates communication frequency based on the state information of the managed computer 2 (S65). The frequency controller 32 then waits until a predetermined time has arrived (S66) and ends this flow. Thereafter, this flow is repeatedly performed.

When information of a new type is to be recorded in the reply buffer 41, a new entry is created for recording thereof. Information of the type that has already existed in the reply buffer is recorded in the same existing entry.

As described above, the management agent 21 can autonomously control the type of an instruction and communication frequency by referring to the management registry 11, thereby controlling the CPU load of the management agent 21. Further, by previously storing a request message to be repeatedly used in the request template buffer 43 for repetitive use of the message, it is possible to reduce the number of times of processing that creates a request message, thereby reducing the CPU load of the management agent 21.

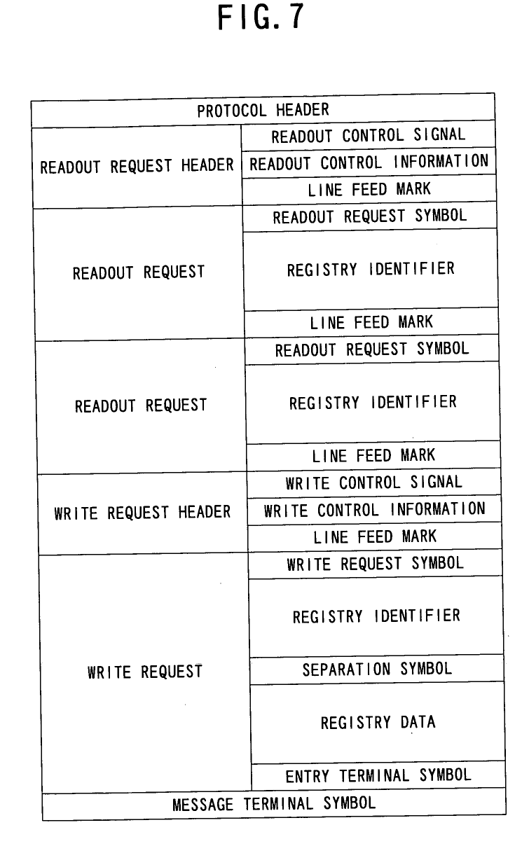

FIG. 7 is a view showing an example of a format of a request message according to the present invention. The request massage starts with a protocol header. If necessary, a readout request header and some readout requests are added. Further, if necessary, a write request header and some Write requests are added. The request massage ends with a message terminal symbol. The readout request header includes readout control symbol, readout control information, and line feed mark. The number of the subsequent readout requests is determined according to need. One readout request includes readout request symbol, registry identifier that indicates the entry to be read out, and line feed mark. The write request header includes write in control symbol, write in control information, and line feed mark. The number of the subsequent write requests is determined according to need. One write request includes write request symbol, registry identifier that indicates the entry to be subjected to write operation, registry data which is the content to be written, and line feed mark. The format of the write request is the same as that of the entry of the management registry 11 in FIG. 2, so that the write request can be written as an entry of the management registry 11 without change.

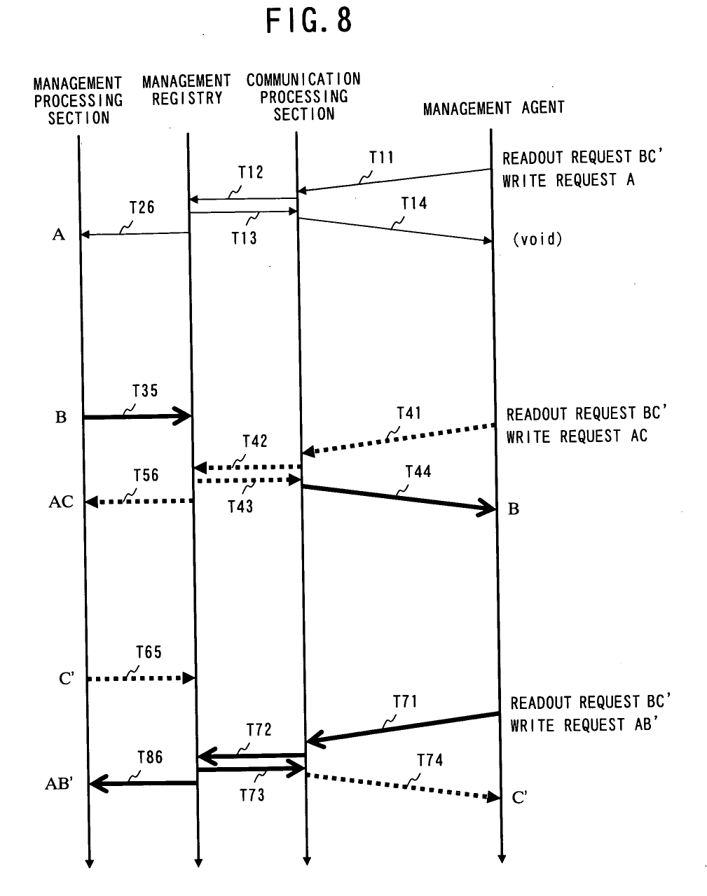

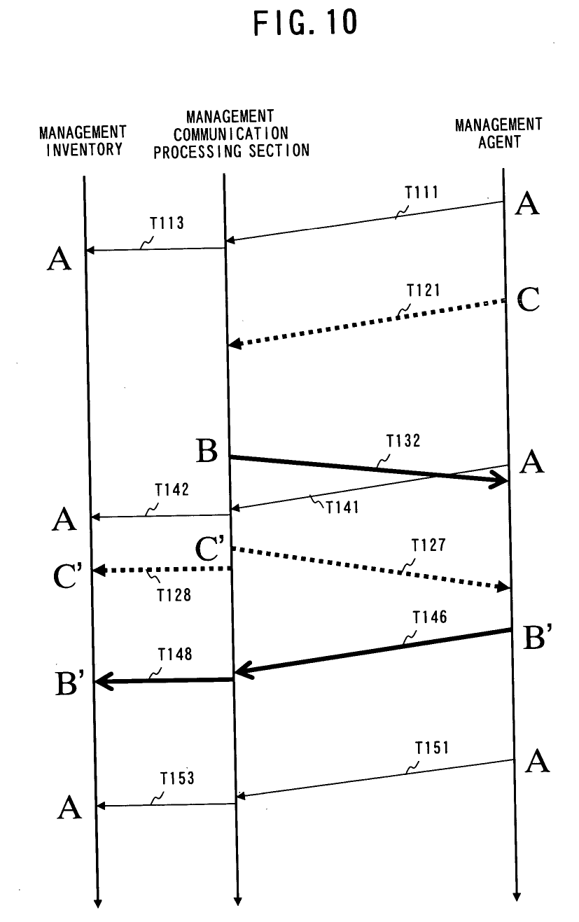

Next, a concrete example of operation of the computer management system will be described. FIG. 8 is a sequence diagram showing an example of operation of the computer management system according to the present invention. In FIG. 8, the same reference numerals denote the same or corresponding processing as in FIG. 10, and the descriptions thereof will be omitted. The contents of information A, information B, information B′, information C, and information C′ are the same as those in FIG. 10. In the initial state, the entry in the management registry 11 is void.

The management agent 21 transmits readout requests of information B and information C′ (readout request BC′) and a write request of information A (write request A) to the communication processing section 13 as one request message (T11). Upon receiving the request message, the communication processing section 13 writes the information A in the management registry 11 as a new entry according to the write request (T12). Further, the communication processing section 13 tries to read out the information B and information C′ according to the readout request. However, neither of the information B and information C′ exist in the management registry 11. The communication processing section 13 therefore cancels the readout operation (T13) and transmits a void reply message to the management agent 21 (T14). Then, the management processing section 12 reads out the information A (T26) in a periodical readout operation for the management registry 11, performs processing according to the information A, and writes the information B in the management registry 11 as a new entry (T35).

Next, the management agent 21 transmits readout requests of information B and information C′ (readout request BC′) and write requests of information A and information C (write request AC) to the communication processing section 13 as one request message (T41). Upon receiving the request message, the communication processing section 13 updates the entry of the information A according to the write request and writes the information C as a new entry in the management registry 11 (T42). Further, the communication processing section 13 tries to read out the information B and information C′. However, although the information B exists in the management registry 11, the information C′ does not exist therein. The communication processing section 13 therefore reads out only the information B (T43) and transmits it to the management agent 21 as a reply message (T44). Upon receiving the reply message, the management agent 21 performs processing according to the information B. Then, the management processing section 12 reads out the information A and information C (T56) in a periodical readout operation for the management registry 11, performs processing according to the information A and information C, and updates the entry of the information C with the information C′ in the management registry 11 (T65). The information C′ is a result of the processing that the management processing section 12 has performed according to the information C.

Next, the management agent 21 transmits readout requests of information B and information C′ (readout request BC′) and write requests of information A and information B′ (write request AB′) to the communication processing section 13 as one request message (T71). The information B′ is a result of the processing that the management agent 21 has performed according to the information B. Upon receiving the request message, the communication processing section 13 updates the entry of the information A and further updates the entry of the information B with the information B′ in the management registry 11 (T72). The communication processing section 13 then tries to read out information B and information C′ according to the readout message. However, although the information C′ exists in the management registry 11, the information B does not exist therein. The communication processing section 13 therefore reads out only the information C′ (T73) and transmits it to the management agent 21 as a reply message (T74). Upon receiving the reply message, the management agent 21 performs processing according to the information C′. Then, the management processing section 12 reads out the information A and information B′ (T86) in a periodical readout operation for the management registry 11 and performs processing according to the information A and information B′.

Further, it is possible to provide a program that allows a computer constituting the computer management apparatus to execute the above steps as a computer management program. By storing the above program in a computer-readable storage medium, it is possible to allow the computer constituting the computer management apparatus to execute the program. Further, it is possible to provide a program that allows a computer constituting the managed computer to execute the above steps as a managed computer control program. By storing the above program in a computer-readable storage medium, it is possible to allow the computer constituting the computer management apparatus to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

The communication processing section 31, request buffer 42, request message template creation section 35, and request message template buffer 43 in the embodiment correspond to a request message transmission section. The communication processing section 31 and reply buffer 41 in the embodiment correspond to a request message reception section.

What is claimed is:

1. A computer management program allowing a computer to execute a computer management method for managing one or more managed computers, the program allowing the computer to execute:
a communication processing step that receives a request message from the managed computer, writes information from the managed computer in a management registry that stores information for managing the managed computer in the case where the request message includes a write request, and reads out information for the managed computer from the management registry so as to transmit a result of the readout operation to the managed computer as a reply message in the case where the request message includes a readout request; and
a management processing step that reads out information of the managed computer from the management registry, performs management processing for the managed computer according to a result of the readout operation, and writes information for the managed computer, which is to be obtained by a result of the management processing, in the management registry.

2. The computer management program according to claim 1, wherein
the communication processing step inhibits another access to the management registry while the communication processing step accesses the management registry.

3. The computer management program according to claim 1, wherein
the communication processing step or management processing step sets a survival time for each entry in the management registry and initializes the entry when a time has elapsed exceeding the survival time for the entry since the last update time thereof.

4. A managed computer control program communicating with a computer management apparatus and allowing a computer to execute a managed computer control method that controls the managed computer, the program allowing the computer to execute:
a state monitor step that monitors the state of the managed computer and acquires the state of the managed computer as state information;
a request message transmission step that transmits a request message to the computer management apparatus according to the state information;
a reply message reception step that receives a reply message corresponding to the request message from the computer management apparatus;
a management control step that controls the managed computer according to the reply message; and
a frequency control step that controls, according to the state information, the frequency of transmission performed by the request message transmission step.

5. The managed computer control program according to claim 4, wherein
the state information includes a CPU load of the managed computer.

6. The managed computer control program according to claim 4, wherein
the request message transmission step previously stores, as a request message template, a request message to be repeatedly used and, when there is a request to transmit the request message to be repeatedly used, transmits the corresponding stored request message template.

7. A computer management apparatus that manages one or more managed computers, comprising:
a management registry that stores information for managing the managed computer;
a communication processing section that receives a request message from the managed computer, writes information from the managed computer in a management registry in the case where the request message includes a write request, and reads out information for the managed computer from the management registry so as to transmit a result of the readout operation to the managed computer as a reply message in the case where the request message includes a readout request; and
a management processing section that reads out information from the managed computer in the management registry, performs management processing for the managed computer according to a result of the readout operation, and writes information for the managed computer, which is to be obtained by a result of the management processing, in the management registry.

8. The computer management apparatus according to claim 7, wherein
the communication processing section inhibits another access to the management registry while the communication processing section accesses the management registry.

9. The computer management apparatus according to claim 7, wherein
the communication processing section or management processing section sets the survival time for each entry in the management registry and initializes the entry when a time has elapsed exceeding the survival time for the entry since the last update time thereof.

10. A managed computer that communicates with a computer management apparatus and is managed by the same, comprising:
a state monitor section that monitors the state of the managed computer and acquires the state of the managed computer as state information;
a request message transmission section that transmits a request message to the computer management apparatus according to the state information;
a reply message reception section that receives a reply message corresponding to the request message from the computer management apparatus;
a management control section that controls the managed computer according to the reply message; and
a frequency control section that controls, according to the state information, the frequency of transmission performed by the request message transmission section.

11. The managed computer according to claim 10, wherein
the state information includes the CPU load of the managed computer.

12. The managed computer according to claim 10, wherein
the request message transmission section previously stores, as a request message template, a request message to be repeatedly used and, when there is a request to transmit the request message to be repeatedly used, transmits the corresponding stored request message template.

13. A computer management system that manages computers on a network, comprising:
one or more managed computers to be managed; and
a computer management apparatus that communicates with the managed computer to thereby manage the same,
the managed computer comprising:
a state information acquisition section that acquires the state information of the managed computer; a request message transmission section that transmits a request message to the computer management apparatus according to the state information; a reply message reception section that receives a reply message corresponding to the request message from the computer management apparatus; a management control section that controls the managed computer according to the reply message; and a frequency control section that controls, according to the state information, the frequency of transmission performed by the request message transmission section,
the computer management apparatus comprising: a management registry that stores information for managing the managed computer; a communication processing section that receives a request message from the managed computer, writes information from the managed computer in a management registry in the case where the request message includes a write request, and reads out information for the managed computer from the management registry so as to transmit a result of the readout operation to the managed computer as a reply message in the case where the request message includes a readout request; and a management processing section that reads out information from the managed computer in the management registry, performs management processing for the managed computer according to a result of the readout operation, and writes information for the managed computer, which is to be obtained by a result of the management processing, in the management registry.

14. A computer management method that manages one or more managed computers, comprising:
a communication processing step that receives a request message from the managed computer, writes information from the managed computer in a management registry that stores information for managing the managed computer in the case where the request message includes a write request, and reads out information for the managed computer from the management registry so as to transmit a result of the readout operation to the managed computer as a reply message in the case where the request message includes a readout request; and
a management processing step that reads out information from the managed computer in the management registry, performs management processing for the managed computer according to a result of the readout operation, and writes information for the managed computer, which is to be obtained by a result of the management processing, in the management registry.

15. The computer management method according to claim 14, wherein
the communication processing step inhibits another access to the management registry while the communication processing step accesses the management registry.

16. The computer management method according to claim 14, wherein
the communication processing step or management processing step sets the survival time for each entry in the management registry and initializes the entry when a time has elapsed exceeding the survival time for the entry since the last update time thereof.

17. A managed computer control method that communicates with a computer management apparatus and controls a managed computer, comprising:
a state monitor step that monitors the state of the managed computer and acquires the state of the managed computer as state information;
a request message transmission step that transmits a request message to the computer management apparatus according to the state information;
a reply message reception step that receives a reply message corresponding to the request message from the computer management apparatus;
a management control step that controls the managed computer according to the reply message; and
a frequency control step that controls, according to the state information, the frequency of transmission performed by the request message transmission step.

18. The managed computer control method according to claim 17, wherein
the state information includes the CPU load of the managed computer.

19. The managed computer control method according to claim 17, wherein
the request message transmission step previously stores, as a request message template, a request message to be repeatedly used and, when there is a request to transmit the request message to be repeatedly used, transmits the corresponding stored request message template.
